(19) United States
(12) Patent Application Publication
(10) Pub. No.: US 2003/0189165 A1
(43) Pub. Date: Oct. 9, 2003

(54) Car seat monitoring device

(76) Inventors: Derrick Anthony Fitzroy Samuels SR., Barnet, VT (US); Edward George Kearns, North Haven, CT (US); James Edward Kemble, Newbury, VT (US)

Correspondence Address: DERRICK AF SAMUELS SR., 609 BARNET CENTER RD., BARNET, VT, 05821, US

(21) Appl. No.: 10/045,999

(22) Filed: Apr. 5, 2002

(51) Int. Cl. G06M 7/00

(52) U.S. Cl. 250/221

(57) ABSTRACT

A Child Seat monitoring system for use in automobiles. An optical arrangement is situated in the vehicle such that a driver of the vehicle may view the occupant of the Child Seat for position, disposition or presence in the seat. The Child Seat contains a sensing device to detect the presence or not of an occupant. An alarm is given when the driver's door of the vehicle is opened and the Child Seat is occupied. The optical system includes lights for illumination of the Child Seat. The optical system may be used separately from the Seat sensors or vice versa.

### BRIEF DESCRIPTION OF THE DRAWINGS.

FIGS. 1 & 1A are views of a typical case of the implementation of the device in an automobile.

FIG. 2 is a perspective view of the device showing the disposition of the major components.

FIG. 2A is a side view elevation of the device.

FIG. 2B is a side view elevation of the device mounted on the back-rest of a rear seat.

FIG. 3 & 3A are views of a typical installation showing the child seat located on the back seat of a vehicle with the device 5 on the car seat back-rest. 1.

FIG. 4 is a perspective view of a typical Child Seat showing the disposition of sensors and illuminating devices contained within the seat.

### DETAILED DESCRIPTION OF THE INVENTION.

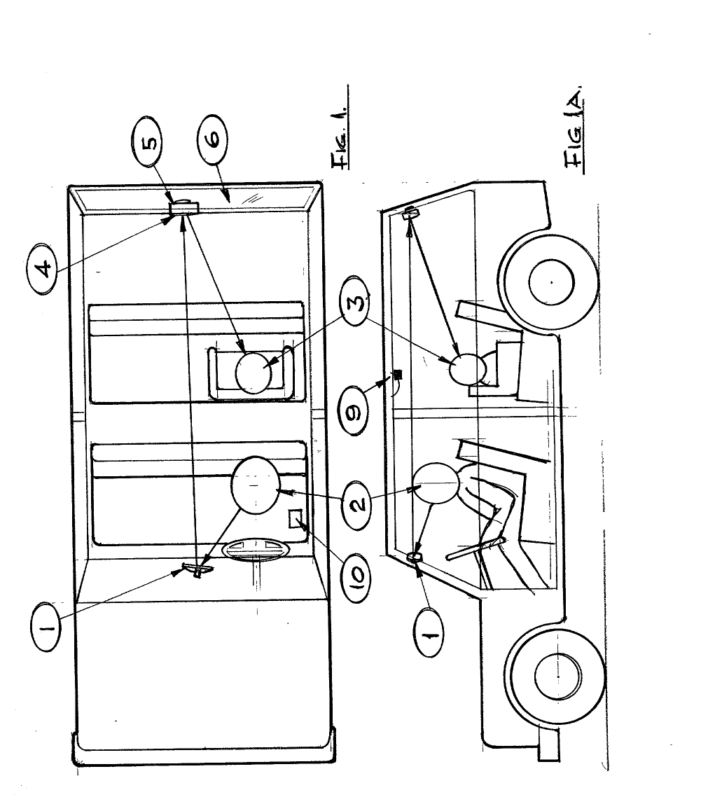

With reference to FIGS. 1 & 1a. The substance of the invention is that by use of the vehicles rear view mirror 1 the driver 2 of the vehicle can view the child seat's occupant 3 reflected in the convex mirror 4 of the device 5. The device 5 is positioned and secured at a convenient point on the internal surface of a window 6 such that the convex mirror 4 can be oriented to provide a clear view of the child seat 3. The arrows show these reflected paths. Alternatively the device may be mounted across the back of a rear seat 7 in the automobile. A further feature of the device is the incorporation of a sensor 8 detecting the presence or not of an occupant of the child seat 3. In the case of a vehicle door being opened, a separate transmitter 9, positioned in close proximity to a dome light, and in conjunction with the sensor 8 will cause the device to emit an audible warning. For use at night or in poor light conditions a collimated light source 11 is incorporated in the device. The light source may be activated by a radio, infrared, or ultrasonic signal sent by the driver 2 from either a dedicated transmitter, a transmitter as contained in a remote control key-fob or a garage door-opening transmitter 10. This signal will be encoded so that multiple unite can be in close proximity. All battery states are monitored and voice messages are broadcast when batteries become near exhausted.

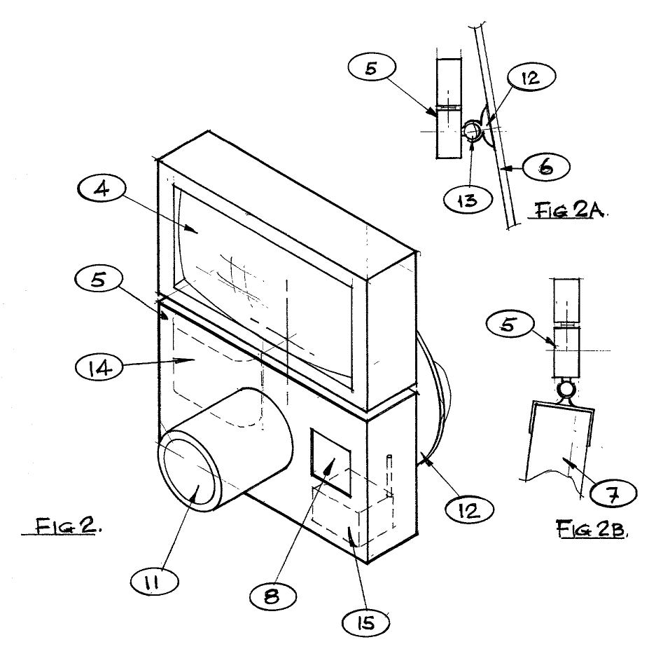

Turning to FIG. 2. The device is shown in perspective. The device is fixed to a convenient position on a window 6 by means of a suction pad 12. The main unit may be swiveled in both planes by means of a ball and socket 13 to direct the beam of the collimated light source 11 onto the child seat 3 and its' occupant. The alignment of the light source 11 also aligns the sensor 8 detecting the presence or not of the occupant of the child seat 3. The collimated light source 11 is located in the main enclosure of the device 5. This light source may be an array of high intensity light-emitting diodes or an incandescent source and is powered by rechargeable batteries 14 housed in the main enclosure. These batteries also power the radio receiver 15 positioned in the main enclosure. The radio receiver 15, when receiving a 2. signal from the drivers' transmitter 10, activates the light source 11. The convex mirror 4 is independently adjustable to allow the optimum view of the child seat 3 for the driver 2 of the vehicle.

FIG. 2A is a side elevation of the device showing the incorporation of the ball and socket 13 between the device and the suction pad 12.

FIG. 2B is a side view elevation showing alternative placing of the device 5 on the backrest of a rear seat 7.

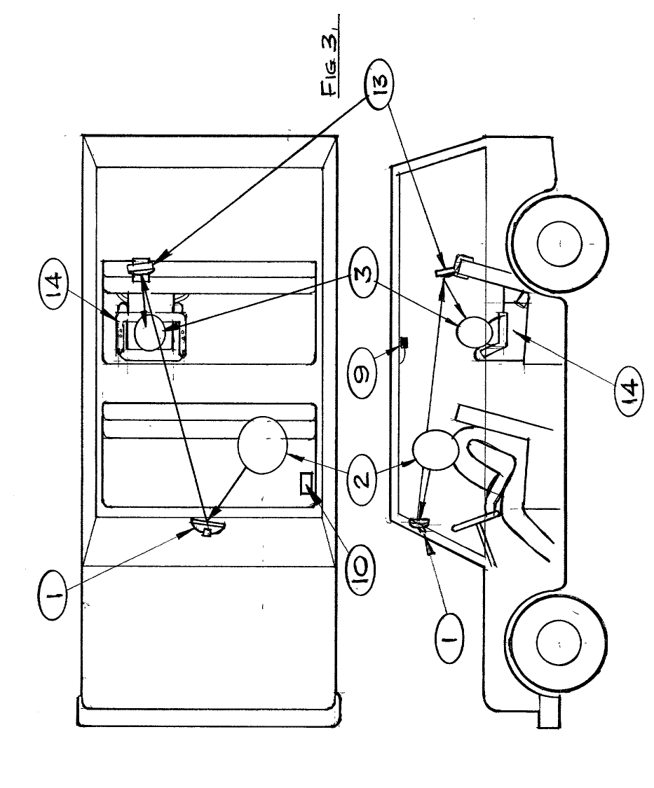

With reference to FIGS. 3 & 3A. These figures illustrate a generic Child Seat 14 installed on the rear seat of a vehicle. The seat 14 may be positioned as shown or be located behind the driver 2. The additional mirror 13 is shown on the rear seat back-rest, but this mirror 13 may be placed in any convenient position to suit the vehicle used, for example, on side or rear windows Alternatively this mirror 13 could be an integral part of the Child Seat 14.

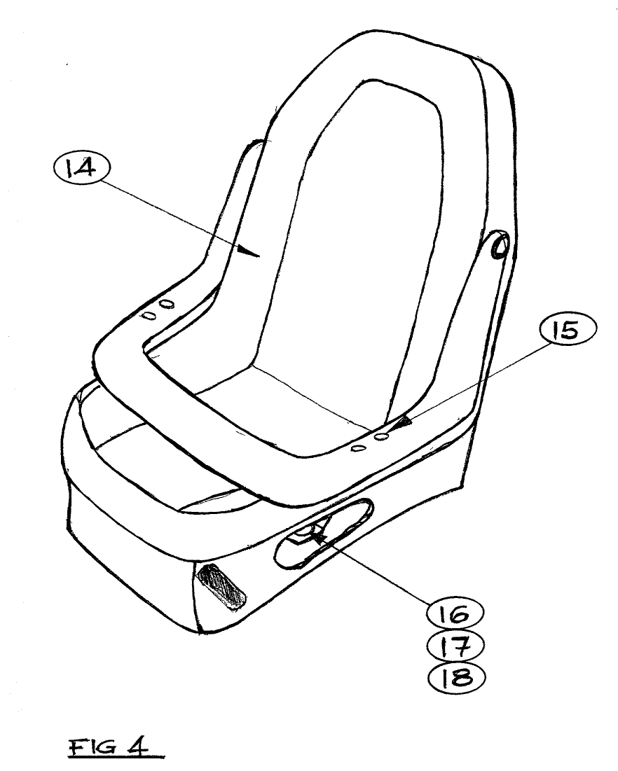

FIG. 4 is a perspective view of a generic Child Seat 14. This seat incorporates a sensor 17, either permanently or temporarily attached, and lighting units 15 to illuminate the seats' occupant. This sensor 17 is an alternative to that shown in FIG. 2, item 8, and works in like manner, advising the driver 2 of the presence or not of an occupant of Child Seat 14. The lighting units may be switched on by the driver 2 using a dedicated transmitter, as described above in the description of FIGS. 1 & 1A. Battery states are monitored in all embodiments and voice messages emitted as necessary.

We claim as our invention a child seat monitoring system, comprising:

I. An optical system;
using mirrors within a vehicle to view the occupant of a child seat which is not in the normal vision of the driver of the vehicle,
an integral sensing device,
an integral light source,
an integral receiver of either radio, infrared or ultrasonic signals,
a separate transmitter of either radio, infrared or ultrasonic nature,
a second transmitter positioned on an interior roof light in the vehicle.

II. A device as in claim I, further comprising:
a separate child seat containing the integral sensing device.

III. A device as in claim I, further comprising:
a separate child seat containing the integral sensing device and an integral light source.

IV. A child seat monitoring system, comprising:
a child seat containing an integral sensing device and a receiver of either radio, infrared or ultrasonic signals, with an audio amplifier to broadcast a voice message,
a transmitter attachable to an interior roof light.

V. A monitoring system comprising:
a sensing unit, placed in use under the occupant of a child seat or vehicle seat, and a connected receiver of either radio, infrared or ultrasonic signals, with an integral audio amplifier to broadcast voice messages, a transmitter attachable to an interior roof light.
